(19) United States
(12) Patent Application Publication
(10) Pub. No.: US 2009/0172339 A1
(43) Pub. Date: Jul. 2, 2009

(54) Apparatus and method for controlling queue

(75) Inventor: Koji Kobayashi, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 12/285,762

(22) Filed: Oct. 14, 2008

(30) Foreign Application Priority Data
Dec. 28, 2007 (JP) 2007-338861

(51) Int. Cl. G06F 12/02

(52) U.S. Cl. 711/202; 711/E12.002

(57) ABSTRACT

An apparatus includes a queue element which stores a plurality of memory access requests to be issued to a memory device, the memory access requests including a store request and a load request, and a controller which controls the queue element. The controller includes an address decision element which decides whether a first address of a first memory access request and a second address of a second memory access request relate with each other. The controller issues the second memory access request together with issuing of the first memory access request when the first address and the second address relate with each other.

### INCORPORATION BY REFERENCE

This application is based upon and claims the benefit of priority from Japanese patent application No. 2007-338861, filed on Dec. 28, 2007, the disclosure of which is incorporated herein in its entirety by reference.

### BACKGROUND OF THE INVENTION

1. Field of the Invention

The present invention relates to an apparatus and a method of controlling a load/store queue which stores a request to be issued to a main memory unit, and more particularly to an apparatus and a method for controlling the load/store queue provided between a cache memory (hereafter “cache”) and the main memory unit.

2. Description of Related Art

In recent years, when a load/store request is issued from a processor to a cache or when the load/store request is issued from a cache to a main memory unit, a load/store queue is used to conceal an access latency and a difference of a data transfer performance between the processor and the cache, or the cache and the main memory unit. The load/store queue has been provided between the processor and the cache, or between the cache and the main memory unit.

For example, the following techniques have been used for improving the access latency and the data transfer performance of the load/store queue.

(1) If a store request waiting to be issued in a store queue is followed by a load request including the same address as that of the store request, then the load access request is not issued to the cache or the main memory unit. Instead, a data in the store queue waiting to be issued by the store request is replied (returned) as the load access result, thereby reducing the access time.

(2) Another a technique is that a load request taking more processing time than a store request is issued antecedent to the store request which is stored in the queue antecedent to the load request.

(3) If a store request is followed by a request including a same address as that of the preceding store request, then the store request is compressed by replacing or merging the store data. Methods for speeding up these functions have also been proposed.

In Patent Document 1, a technique related to the load/store queue installed between the processor and the cache is described. In Patent Document 1, when a store data is not ready for issue after a store request is issued, if the store request does not include a same address as that of a load request which is issued after the store request, then an issuing order is changed in a load/store queue to issue the load request antecedent to the store request. In other words, in Patent Document 1, when an issuance of the store request is delayed, the load request which includes an address different than that of the store request is issued antecedent to the store request.

A technique for merging store requests which include a same address is described in Patent Document 2.

Patent Documents 3 and 4 propose a speed-up method related to a load request following a store request including the same address.

[Patent Document 1]: Japanese Patent Laid-Open No. 06-131239

[Patent Document 2]: Japanese Patent Laid-Open No. 01-050139

[Patent Document 3]: Japanese Patent Laid-Open No. 2000-259412

[Patent Document 4]: Japanese Patent Laid-Open No. 2002-287959

### SUMMARY OF THE INVENTION

According to one exemplary aspect of the present invention, an apparatus includes a queue element which stores a plurality of memory access requests to be issued to a memory device, the memory access requests including a store request and a load request, and a controller which controls the queue element, wherein the controller includes an address decision element which decides whether a first address of a first memory access request and a second address of a second memory access request relate with each other, wherein the controller issues the second memory access request together with issuing of the first memory access request when the first address and the second address relate with each other.

According to another exemplary aspect of the present invention, a method includes storing a plurality of memory access requests to be issued to a memory device in a queue element, the memory access requests including a store request and a load request, deciding whether a first address of a first memory access request and a second address of a second memory access request relate with each other, and issuing the second memory access request together with issuing of the first memory access request when the first address and the second address relate with each other.

### BRIEF DESCRIPTION OF THE DRAWINGS

Other exemplary aspects and advantages of the invention will be made more apparent by the following detailed description and the accompanying drawings, wherein:

FIG. 1 is an exemplary schematic drawing of the present invention;

FIG. 2 is another exemplary schematic drawing of the present invention;

FIG. 3 is an exemplary flowchart of the present invention;

FIG. 4 is another exemplary flowchart of the present invention; and

FIG. 5 is an exemplary block diagram of the present invention.

### DETAILED DESCRIPTION OF THE EXEMPLARY EMBODIMENTS

All techniques described in Patent Documents 1 to 4 relate to the load/store queue installed between the processor and the cache. However, these techniques do not intend to improve a performance and reduce a power consumption with respect to an access latency and data transfer by using characteristics of the main memory unit, e.g., a DRAM, a synchronous DRAM, a DIMM or a SIMM using the DRAM or the synchronous DRAM.

Regarding a load/store queue between a processor and a cache, an activation of a row address or a bank (rank) address for accessing a main memory unit does not become a problem, since a request issued by the processor does not directly access to the main memory unit. Regarding the load/store queue between the cache and the main memory unit such as DRAM or SDRAM for example, a row address strobe (RAS) is activated at first, and then a column address strobe (CAS) is activated when the main memory is accessed.

Regarding the load/store queue between the cache and the main memory unit such as DIMM or SIMM for example, a bank (rank) is designated for activating an access to the main memory since an access designation is different according to the bank (rank). The activation of the row address may be required in a DRAM for example, and the activation of the bank (rank) may be required in a DIMM or a SIMM, for example.

As opposed to the SRAM, the DRAM or the SDRAM includes a burst transfer feature that where access to the same row address is successively made, enables high-speed access to data merely by changing the column addresses after outputting the row address. However, when the address is activated every time for accessing to the main memory unit, if there are a plurality of load requests each of which include a same row address, the activation of the row address is required for each of the load requests. Thus, a number of executions of the activation is increased. Therefore, because of the increased number of executions of the activation, an access latency and a data transfer are deteriorated.

In the present invention, the number of executions of the activation is decreased, and thus, the access to the main memory unit may become more effective. Therefore, the access latency and the data transfer are improved, and a power consumption for accessing the main memory is decreased.

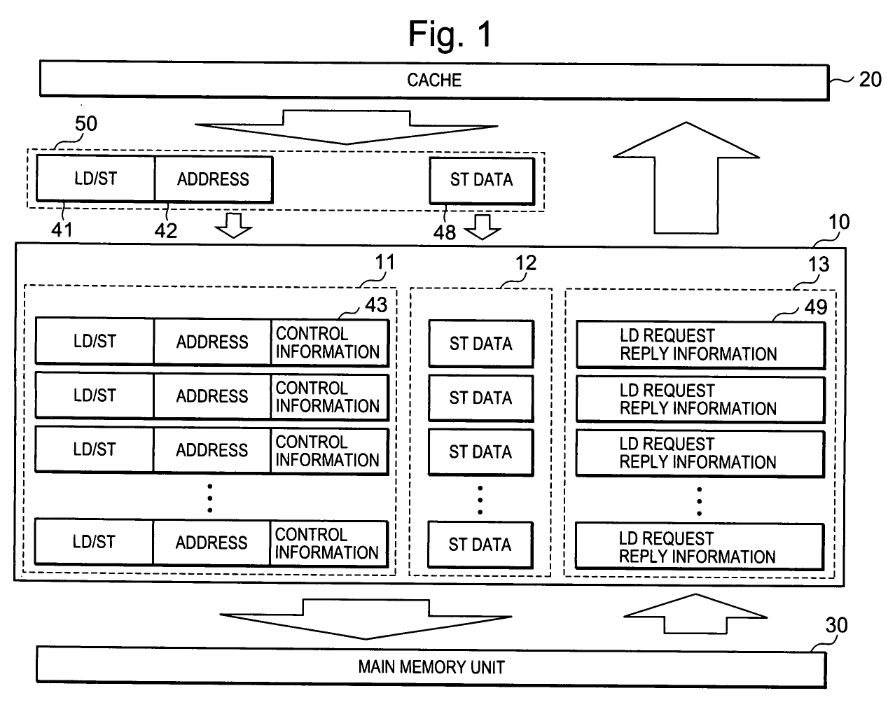

As shown in FIG. 1, a load/store queue 10 is installed between a cache 20 and a main memory unit 30. The load/store queue 10 holds a request to be issued to the main memory unit 30. The load/store queue 10 may be a load/store queue which directly issues a request to the main memory unit 30 and the unit which issues a request to the load/store queue 10 is not limited to the cache 20 The load/store queue may be a load/store queue to which a request is directly issued from a processor (not shown).

The cache 20 newly issues a request 50 to the load/store queue 10. The request 50 includes request type information (LD/ST) 41 indicating whether the request is the load request or the store request, an address 42 specifying data to be used by the request, and store data 48 to be stored in the main memory unit 30.

The load/store queue 10 includes a request queue 11 which actually issues a request to the main memory unit 30, a store data queue 12 which holds the store data 48, and a reply queue 13 which holds reply information (LD request reply information 49) in response to the load request. The load/store queue 10 may further include a load queue which holds load data, although it is omitted in FIG. 1.

The load requests and the store requests which are issued in random order are sorted in the load/store queue 10 such that an order of the load and store requests become a string of the load requests and a string of the store requests (i.e., load requests are sequentially grouped together and store requests are sequentially grouped together). A control information 43 is added to the request 50 which is newly issued from the cache 20 to the load/store queue 10 for sorting the requests 50 in the load/store queue 10.

Regarding a queue in the load/store queue 10, a queue closer to the main memory unit 30 is defined as a preceding queue, and a request which is newly issued to the load/store queue 10 is moved to the preceding queue in the load/store queue 10.

The load and store requests which are sorted in the load/store queue 10 are issued to the main memory unit 30 When the request is the store request, the store data 48 is transferred to the main memory unit 30 and is stored in the specified address 42. When the request is the load request, load data and LD request reply information 49 about the load request are transferred from the main memory unit 30 to the load/store queue 10. When there are load requests which designate a same memory address in the request queue 11, the requests are compressed (by replacing or merging the data) into one request and issued to the main memory unit 30. However, the LD request reply information 49 holds the load request information which is not compressed. The load data from the main memory unit 30 is checked against the LD request reply information, and replied (e.g., returned) for each load request from the cache 20.

For example, the request queue 11 and the reply queue 13 in the load/store queue 10 may be made of a flip-flop (FF), and the store data queue 12 may be made of a random access memory (RAM). The main memory unit 30 may be made of a DRAM or a synchronous DRAM (SDRAM), and furthermore, may be made of a dual in-line memory module (DIMM) or a single in-line memory module (SIMM) using these DRAMs.

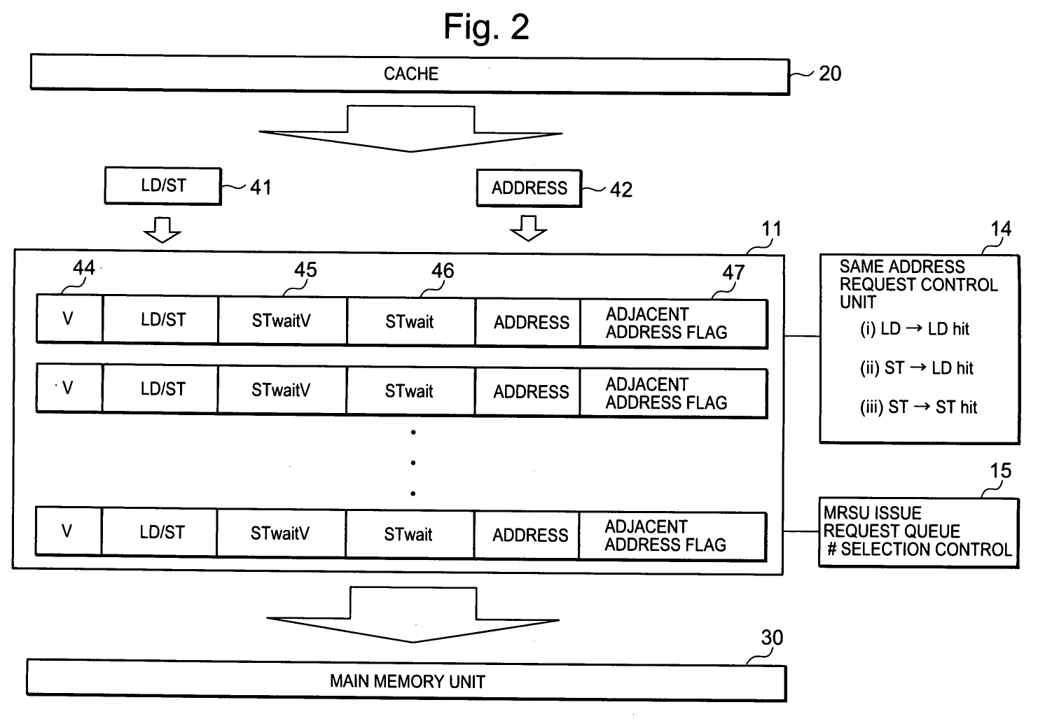

As shown in FIG. 2, the control information 43 of a request held in the request queue 11 includes valid information (V 44) indicating the validity of the request a store wait count (STwait 46), a store wait valid (STwaitV 45), and an adjacent address flag code 47.

The STwait 46 and the STwaitV 45 are used for retaining the store request in the load/store queue 10 until a predetermined condition is satisfied. For example, as a predetermined condition, when a number of the requests subsequent to the store request becomes a predetermined value, the store requests retained in the load/store queue 10 are issued to the main memory unit 30.

The number of requests subsequent to the store request is counted by using the STwait 46. When the count value reaches a predetermined value, the STwaitV 45 is set. When the STwaitV 45 is set, the store requests retained in the load/store queue 10 are issued to the main memory unit 30. In other words, the store requests are retained in the load/store queue 10 without being issued to the main memory unit 30 until the STwait 46 reaches the predetermined value and the STwaitV 45 is set.

The store requests are retained in the load/store queue 10 until the number of requests newly issued to the load/store queue 10 reaches the predetermined value. So, many store requests are retained in the load/store queue 10 when there are the store requests, which include the same designated memory address, subsequent to the preceding store request. Therefore, the store requests are merged efficiently, and the string of the store requests are issued to the main memory unit 30 separately from the string of the load requests.

The adjacent address flag code 47 may be used for sorting the requests which are stored in the load/store queue 10 based on a predetermined unit of processing of addresses in the main memory unit 30. The addresses in the main memory unit 30 are divided into a plurality of units of processing, and the adjacent address flag code 47 is identification information indicating any one of the units of processing. For example, the predetermined unit may mean (e.g., represent) that a rank of the memory unit 30, a row address of the memory unit 30, etc. The requests may be sorted and controlled according to the address corresponding to the predetermined units by assigning the adjacent address flag code 47 to each of the requests which are stored in the load/store queue 10. For example, the same adjacent address flag code 47 may be assigned to a request including the same row address, and the same adjacent address flag code 47 may be assigned to a request including the same rank address.

The addresses of the requests which are stored in the load/store queue 10 are compared with addresses corresponding to newly issued requests. And, the requests which are stored in the load/store queue 10 and the newly issued requests are classified by adding the adjacent address flag code 47 to these requests. When the request which is stored in the load/store queue 10 is issued to the main memory unit 30, the requests including the same adjacent address flag code 47 are issued collectively and continuously to the main memory unit 30.

For example, when the load request is issued to the main memory unit 30 by a memory request selection unit (MRSU 15), a multiplexer may be controlled so as to select the load requests including the same adjacent address flag code 47 in the load/store queue 10 and continuously issue all the load requests which include the same adjacent address flag code 47.

When the store request is issued to the main memory unit 30, at first, the store request whose STwaitV 45 is set is issued to the main memory unit 30, and then, the store requests including the same adjacent address flag code 47 are continuously issued to the main memory unit 30. However, the store request may be issued before the STwaitV 45 is set or the store request may be selected and issued thereto from the store requests whose STwaitV 45 is set.

The same address request control unit 14 executes below mentioned procedures, (i) to (iii), regarding the requests including the same address.

(i) When the preceding load request includes the same address as that of the following load request, these load requests are combined into one load request and then issued to the main memory unit 30. The address of a newly issued load request is compared with the addresses of all the load requests which are stored in the load/store queue 10. When the load request including the same address is found, only one of the load requests is placed in the request queue 11 and a plurality of the LD request reply information 49 (the number of the LD request reply information 49 corresponding to the number of the load requests including the same address) are placed in the reply queue 13. A function which is described in (i) is generally implemented in the cache 20, However, if the request source to the load/store queue 10 is not the cache 20, then the present control function may be implemented in the load/store queue 10.

(ii) When the address of the preceding store request is the same as that of the following store request, the two pieces of store data of the store requests are merged into one piece of store data. The address of preceding store request is compared with the address of the following store request for all the store requests which are stored in the load/store queue 10. When the store request including the same address is found, the store data 48 of the following store request is merged into the store data 48 of the preceding store request. In this case, only one store request is placed in the request queue 11 and one piece of merged store data 48 is held in the store data queue 12.

(iii) When the address of the preceding store request is the same as that of the following load request the content of the store data 48 which is held in the store data queue 12 is replied (returned) as the data of the following load request. The address of the newly issued load request is compared with the addresses of all the store requests which are stored in the load/store queue 10. When a store request including the same address is found, the content of the store data 48 which is held in the store data queue 12 is replied (returned) as the load result to the cache.

### 1. First Exemplary Embodiment

A first exemplary embodiment of the present invention will be described in detail with reference to drawings.

According to the first exemplary embodiment, a determination is made to see whether the address of the request in the load/store queue 10 is included in the same unit of (processing) in the main memory unit 30 or not. And, when the request is issued to the main memory unit 30, the requests including an address included in the same unit are issued collectively and continuously.

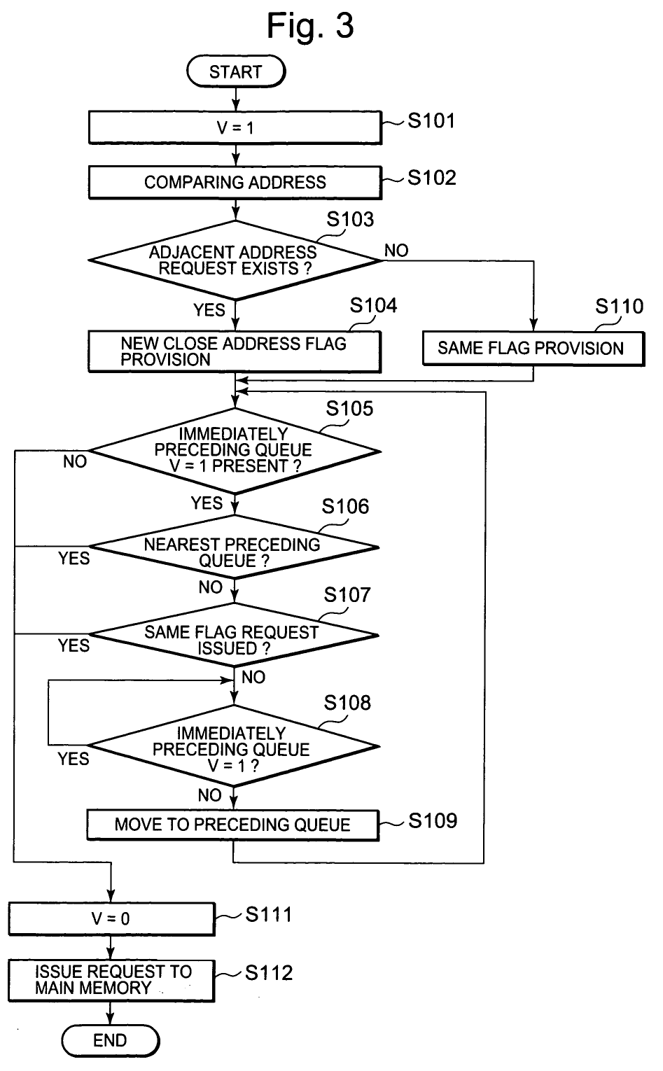

FIG. 3 is an exemplary flowchart showing an example of a procedure of the exemplary embodiment to control requests in the load/store queue. Hereinafter, the load/store queue control method will be described in detail with reference to FIG. 3.

First, the value (V=1) of the valid information V44 of the newly issued request is initialized (step S101). Next, the addresses of all the requests existing in the preceding queue in the load/store queue 10 and the address of the newly issued request are compared with each other (step S102).

As a result of determination in step S102, a determination is made to see whether there is the request including the same row address or the same rank address as the address of the newly issued request in the preceding queue of the load/store queue 10 (step S103). A confirmation is made to see whether there has already been the request in the preceding queue of the load/store queue 10, the request preceding the newly issued request. And, a confirmation is made to see whether the address of the request preceding to the newly issued request includes the same row address or the same rank address as the address of the newly issued request.

If there has already been the request including the same row address or the same rank address as the address of the newly issued request as a result of determination in step S103, then the adjacent address flag code 47 is assigned to the newly issued request (step S110). The adjacent flag code 47 is the same as that assigned to the request including the same row address or the same rank address. On the contrary, if there is no request including the same row address or the same rank address as the address of the newly issued request, then the new adjacent address flag code 47 is created and is assigned to the newly issued request (step S104).

Next, a determination is made to see whether there is the valid request (the request with V=1) in the preceding queue in the load/store queue 10 or not (step S105). If there is not a valid request in the preceding queue as a result of determination, then the process goes to step S111. On the contrary, if there is a valid request in the preceding queue, then a further determination is made to see whether the request is placed in the nearest preceding queue or not (step S106).

If the request is placed in the nearest preceding queue as a result of determination in step S106, then the process goes to step S111. On the contrary, if the request is not placed in the nearest preceding queue, then a further determination is made to see whether a request including the same adjacent address flag code 47 is issued to the main memory unit 30 or not (step S107). A confirmation is made to see whether the requests including the same adjacent address flag code 47 are issued collectively and continuously.

If the request including the same adjacent address flag code 47 is issued to the main memory unit 30 as a result of determination in step S107, then the process goes to step S111. On the contrary, if the request including the same adjacent address flag code 47 is not issued to the main memory unit 30, then a further determination is made to see whether the request in the immediately preceding queue is the valid request (V=1) or not (step S108).

If the request in the immediately preceding queue is the valid request as a result of determination in step S108, then the process returns to step S108 again. On the contrary, if the request in the immediately preceding queue is not the valid request, then the request is moved to the preceding queue, and the process goes to step S205 (step S109).

On the contrary, if the request is ready to be issued to the main memory unit 30 as a result of determinations in step S105, S106, and S107, then the value of the valid information V44 of the request is cleared (V=0) (step S111). Then, the request is issued from the load/store queue 10 to the main memory unit 30 (step S112).

As described above, when the address of the request which is stored in the load/store queue 10 is the same as the row address or the rank address, the request including the same adjacent address flag code 47 is issued to the main memory unit 30. Thereby, the main memory unit 30 may be continuously accessed by the same row address or by the same rank address. Therefore, when a request is issued from the load/store queue 10 to the main memory unit 30, an RAS (Row Address Strobe) may be activated only once for one transfer of the same row address, thereby reducing the number of RAS activations.

In addition, in the case where a DIMM or the like is used in the main memory unit 30, and higher-speed access can be provided for the case where the same rank address accesses continue than the case where different rank address accesses continue, the same rank address accesses may continue, and thus the process of the main memory unit 30 may be sped up.

### 2. Second Exemplary Embodiment

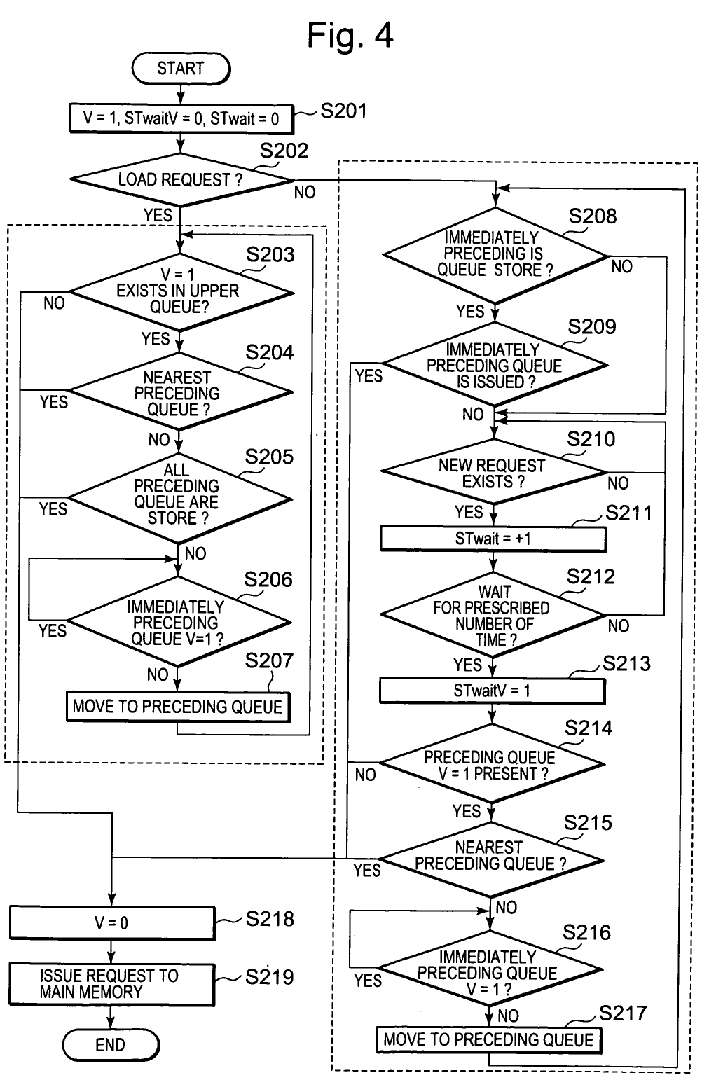

According to the second exemplary embodiment, the requests which are stored in the load/store queue 10 are sorted so that the order of the requests becomes a string of the load requests and a string of the store requests. FIG. 4 is an exemplary flowchart showing an example of a procedure of the second exemplary embodiment. As shown in FIG. 4, the steps from step S203 to S207 control the order of the newly issued load request. The steps from step S208 to S217 control so as to place the newly issued store request in a standby state and controls the order of the store requests.

It should be noted that in the case where there is a preceding store request including the same address as that of a load request in the request queue, and a part of load data is not present as store data, if the store data of the store request may not be replied (returned) as data of the load request to the cache, the store request needs to be issued to the main memory unit ahead of the load request without waiting for a predetermined number of times. However, the control is not the essence of the present invention and thus the description is omitted.

In addition, the first exemplary embodiment shows a control such that if a store request is present in an immediately preceding queue of the store request in the request queue and the immediately preceding queue is issued to the main memory unit, then the request is issued to the main memory unit without waiting for a store request to be issued. The immediately preceding queue means that the order of the immediately preceding queue is one step prior to the queue of the store request which is newly issued to the request queue.

First, the values of the valid information V44, the STwaitV 45, and the STwait 46 of the newly issued request (V=1, STwaitV=0, STwait=0) are initialized (step S201). Next, the request type information (LD/ST) 41 is checked to judge whether the request is the load request or not (step S202).

If the request is not the load request (i.e., the store request) as a result of determination in step S202, then the process goes to step S208. On the contrary, if the request is the load request, then a determination is made to see whether there is a valid request (the request with V=1) in the preceding queue in the load/store queue 10 (step S203) or not. In other words, a confirmation is made to see whether there is a preceding valid request in the load/store queue 10 or not.

If there is not a valid request in the preceding queue as a result of determination in step S203, then the process goes to step S218. On the contrary, if there is the valid request in the preceding queue, then a further determination is made to see whether the request is placed in the nearest preceding queue or not (step S204). In other words, a confirmation is made to see whether the request is the next to be issued to the main memory unit 30.

If the request is placed in a nearest preceding queue, which is the most nearest queue of the load/store queue 10 with respect to the main memory unit 30, as a result of determination in step S204, then the process goes to step S218. On the contrary, if the request is not placed in the nearest preceding queue, further a determination is made to see whether the requests in the preceding queue are all store requests or not (step S205) In other words, a confirmation is made to see whether the requests preceding the load request are all store requests or not.

If the requests in the preceding queue are all store requests as a result of determination in step S105, then the process goes to step S218. On the contrary, if the requests in the preceding queue are not all store requests, then a further determination is made to see whether a request in the immediately preceding queue is a valid request (the request with V=1) (step S206). In other words, a confirmation is made to see whether there is an immediately preceding valid request in the load/store queue 10.

If the request in the immediately preceding queue is a valid request as a result of determination in step S206, then the process returns to step S206 again. In other words, if there is the immediately preceding valid request in the load/store queue 10, then the process is kept standby until the preceding request becomes invalid. On the contrary, if the request in the immediately preceding queue is not the valid request, then the request is moved to the preceding queue and the process returns to step S203 (step S207).

If the request is not the load request (i.e., the store request) as a result of determination in step S202, then a further determination is made to see whether the immediately preceding request is the store request or not (step S208). In other words, a confirmation is made to see whether immediately preceding request is the store request or not.

If the immediately preceding request is not a store request as a result of determination in step S208, then the process goes to step S210. On the contrary, if the immediately preceding request is the store request, then a further determination is made to see whether the immediately preceding request is issued to the main memory unit 30 or not (step S209). In other words, a confirmation is made to see whether the immediately preceding store request has been issued or not.

If the immediately preceding store request has been issued to the main memory unit 30 as a result of determination in step S209, then the process goes to step S218. On the contrary, if the immediately preceding store request is not issued to the main memory unit 30, then a further determination is made to see whether a new request is issued to the load/store queue 10 or not (step S210). In other words, a confirmation is made to see whether the new request subsequent to the store request is issued or not.

If the new request is not issued as a result of determination in step S210, then the process returns to step S210. In other words, the process is kept standby until the subsequent request is issued to the load/store queue 10. On the contrary, if the new request is issued, the value of the STwait 46 is incremented (STwait=+1) (step S211). That is, the number of subsequent requests is counted.

Next, a determination is made based on the value of the STwait 46 to see whether the store request waits for a predetermined number of times in the load/store queue 10 (step S212). In other words, a confirmation is made to see whether the store request is in a ready-to-be-issued state or not.

If the store request does not wait for a predetermined number of times as a result of determination in step S212, then the process returns to step S210. The number of subsequent requests is counted, the store requests are retained in the load/store queue 10 until the count value reaches the predetermined number of times. On the contrary, if the store request waits for the predetermined number of times, then the value of the STwaitV 45 is changed to a valid value (STwaitV=1) (step S213). In other words, the store request is placed in a ready-to-be-issued state.

Next, a determination is made to see whether there is a valid request (the request with V=1) in the preceding queue in the load/store queue 10 or not (step S214). As a result of determination, if there is not the valid request in the preceding queue, then the process goes to step S218. On the contrary, if there is the valid request in the preceding queue, then a determination is made to see whether the request is placed in the nearest preceding queue (step S215).

If the request is placed in the nearest preceding queue as a result of determination in step S215, then the process goes to step S218. On the contrary, if the request is not placed in the nearest preceding queue, then a further determination is made to see whether the request in the immediately preceding queue is a valid request (here, a request with V=1) (step S216).

If the request in the immediately preceding queue is the valid request as a result of determination in step S216, then the process returns to step S216 again. If there is an immediately preceding valid request in the load/store queue 10, then the process is kept in standby until the preceding request becomes invalid. On the contrary, if the request in the immediately preceding queue is not the valid request, then the request is moved to the preceding queue and the process goes to step S208 (step S217).

On the contrary, if the request is ready to be issued to the main memory unit 30 as a result of determinations in steps S203, S204, S205, S209, S214, and S215, then the value of the valid information V44 of the request is cleared (V=0) (step S218). Then, the request is issued from the load/store queue 10 to the main memory unit 30 (step S219), and the entry is released from the request queue.

As described above, the store requests may be continuously retained in the load/store queue 10 by holding the store requests in the load/store queue 10 without being issued to the main memory unit 30 until the number of subsequent requests reaches the predetermined number and by reordering the load requests following the store request ahead of the store request. Therefore, when the request is issued from the load/store queue 10 to the main memory unit 30, the store requests may be continuously issued and the load requests between the store requests may also be continuously issued.

Accordingly, the requests may be efficiently issued to the main memory unit 30 by suppressing the null cycle from occurring in the bus switching between the read cycle and the write cycle, thereby providing performance improvement and low power consumption with respect to access latency and data transfer.

### 3. Third Exemplary Embodiment

According to the third exemplary embodiment, not only the requests which are stored in the load/store queue are sorted so that the order of the requests become a string of the load requests and a string of the store requests, but also the request including the address of the same unit of the main memory unit 30 is issued together as well if the address of a request in the load/store queue 10 is the address of the same unit of processing in the main memory unit 30.

As described in the exemplary flowchart shown in FIG. 3, the store requests which are stored in the load/store queue 10 are retained without being issued to the main memory unit 30 until the number of subsequent requests reaches the predetermined number, and the load requests following the store request are reordered ahead of the store request.

Then, as described in the exemplary flowchart shown in FIG. 4, the requests including the same adjacent address flag code 47 are issued to the main memory unit 30 collectively and continuously. For example, the store requests may be retained in the load/store request by using the STwait 46 and the STwaitV 45 until the predetermined condition is satisfied. For example, the requests which are stored in the load/store queue 10 may be managed based on the unit of the main memory unit 30.

By doing so, when a request is issued from the load/store queue 10 to the main memory unit 30, continuous store requests and continuous load requests may be efficiently issued, thereby providing performance improvement and low power consumption.

Also, when the store request is issued to the main memory unit 30, first the store request whose STwaitV 45 is set may be issued to the main memory unit 30, and then the store request including the same adjacent address flag code 47 may be issued continuously. Or, the store request may be issued to the main memory unit 30 before the STwaitV 45 is set.

As described in the exemplary flowchart shown in FIG. 4, if some of the addresses of the requests in the load/store queue 10 correspond to the same row address or the same rank address, then the requests are sorted so that the order of the requests of the same adjacent address flag code 47 become the string.

Then, as described in the exemplary flowchart shown in FIG. 3, when the number of subsequent store requests reaches the predetermined number, the string of the load requests and the string of the store requests are separated from each other in the requests including the same adjacent address flag code 47 and then may be issued to main memory unit 30.

### 4. Fourth Exemplary Embodiment

According to the fourth exemplary embodiment, as described in the exemplary flowchart shown in FIG. 3, the store requests which are stored in the load/store queue 10 are retained without being issued to the main memory unit 30 until the number of subsequent requests reaches the predetermined number, and the load requests following the store request are reordered ahead of the store request. Further, regarding the addresses of all the store requests, the address of the preceding store request and the address of the following store request are compared, and when the store request including the same address is found, the store data 48 of the following store request is merged with the store data 48 of the preceding store request.

By retaining the store requests until the predetermined condition is satisfied, many store requests are retained in the load/store queue 10. Accordingly, it is possible to improve the merge probability of the store requests and to efficiently issue the store request to the main memory unit 30.

### 5. Fifth Exemplary Embodiment

According to a fifth exemplary embodiment, as described in the exemplary flowchart shown in FIG. 3, the store requests which are stored in the load/store queue 10 are retained without being issued to the main memory unit 30 until the number of subsequent requests reaches the predetermined number, and the load requests following the store request are reordered ahead of the store request. Further, the address of the newly issued load request and the addresses of all the store requests which are stored in the load/store queue 10 are compared, and when the store request including the same address is found, the content of the store data 48 held in the store data queue 12 is replied as the load result without issuing the load request to the main memory unit 30.

By retaining the store requests without being issued, the requests are sorted so that the order of the requests becomes the string of the store requests and the string of the load requests. By retaining as many store requests as possible in the load/store queue 10, the probability that subsequent load requests including the same address as that of the preceding store request, is increased. Therefore, the requests may be issued more efficiently to the main memory unit 30.

### 6. Sixth Exemplary Embodiment

According to a sixth exemplary embodiment, as described in the flowchart shown in FIG. 3, the store requests which are stored in the load/store queue 10 are retained without being issued to the main memory unit 30 until the number of subsequent requests reaches the predetermined number, and the load requests following the store request are reordered ahead of the store request. Further, the address of the newly issued load request and the addresses of all the load requests which are stored in the load/store queue 10 are compared. When the load request including the same address as that of the newly issued load request is found, only one load request which includes the same address is placed in the request queue 11.

By retaining the store requests without being issued, the requests are sorted so that the order of the requests becomes the string of the store requests and the string of the load requests. By placing only one load request which includes the same address, the load request may be further efficiently issued to the main memory unit 30.

### 7. Seventh Exemplary Embodiment

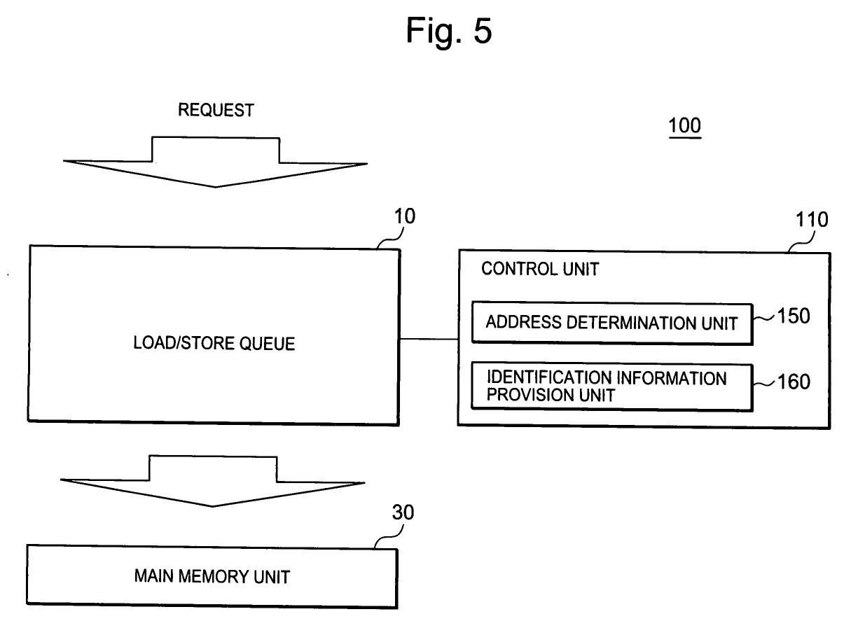

FIG. 5 shows an exemplary functional block diagram of the load/store queue control system in accordance with a seventh exemplary embodiment. The load/store queue control system 100 includes a load/store queue 10 for retaining a request to be issued to the main memory unit 30, and a control unit 110 for controlling the load/store queue 10.

The control unit 110 controls the order of the requests so that the order of the requests becomes the string of the load requests and the string of the store requests by sorting the requests which are stored in the load/store queue 10. The control unit 110 includes a store request control unit 120, a load request control unit 130, a request determination unit 140, and an address determination unit 150. The store request control unit 120 further includes a request measurement unit 121.

The store request control unit 120 retains the store requests in the load/store queue 10 until the predetermined condition is satisfied. For example, the store request control unit 120 retains the store requests in the load/store queue 10 until the number of requests newly issued to the load/store queue 10 reaches the predetermined number. The store request control unit 120 counts the number of requests issued after the store request by the request measurement unit 121, and retains the store requests in the load/store queue 10 until the number of the count value reaches the predetermined number. The store request control unit 120 may be controlled so as to retain the store requests in the load/store queue 10, in the load/store queue 10 for a predetermined time.

The load request control unit 130 sorts the load requests subsequent to the store requests which are retained in the load/store queue 10 so that the load requests become ahead of the store requests which are retained in the load/store queue 10.

The load request control unit 130 uses the request determination unit 140 to determine whether the request ready to be issued from the load/store queue 10 to the main memory unit 30 is the store request or the load request. If the request is the store request, then the store request is retained in the load/store queue 10.

The control unit 110 uses the address determination unit 160 to determine whether the address of a first request and the address of a second request in the load/store queue 10 are the addresses included in the same unit of processing in the main memory unit 30. If the address of the first request and the address of the second request are the addresses included in the same unit of processing in the main memory unit 30, when the first request is issued to the main memory unit 30, the second request is also issued together to the main memory unit 30.

### 8. Other Exemplary Embodiments

In the above described exemplary embodiments 1 to 6, the store request is retained in the load/store queue 10 until the predetermined condition is satisfied. However, the present invention is not limited to these exemplary embodiments. For example, if the request is ready to be issued to the main memory unit 30, then a determination is made to see whether the request is the store request or the load request. As a result of the determination, if the request is the store request, then the store request may be retained in the load/store queue 10. In the above described exemplary embodiments, the store request is retained according to the number of subsequent requests. However, the store request may be retained according to the time (duration) that the store request is present in the load/store queue 10.

In the present invention, the order of the requests is sorted so that the order becomes the string of the store requests and the string of the load requests, and then the requests are issued to the main memory unit 30 according to the sorted order. Accordingly, the present invention may provide performance improvement and low power consumption with respect to access latency and data transfer.

Further, it is noted that applicant's intent is to encompass equivalents of all claim elements, even if amended later during prosecution.

What is claimed is:

1. An apparatus, comprising:
a queue element which stores a plurality of memory access requests to be issued to a memory device, the memory access requests including a store request and a load request; and
a controller which controls the queue element,
wherein the controller comprises:
an address decision element which decides whether a first address of a first memory access request and a second address of a second memory access request relate with each other,
wherein the controller issues the second memory access request together with issuing of the first memory access request when the first address and the second address relate with each other.

2. The apparatus according to claim 1, wherein the address decision element decides that the first address and the second address relate with each other when both of the first and second addresses correspond to a same unit of the memory device.

3. The apparatus according to claim 1, wherein the address decision element decides that the first and second addresses relate with each other when the first and second addresses belong to a same row address.

4. The apparatus according to claim 1, wherein the address decision element decides that the first and second addresses relate with each other when the first and second addresses belong to a same rank of the memory device.

5. The apparatus according to claim 1, wherein both of the first and second memory access requests comprise the store request, or comprise the load request.

6. The apparatus according to claim 1, wherein the controller further comprises:
an identification element which gives a same identification to the first and second memory access requests when the first and second memory access requests relate with each other,
wherein the controller issues the second memory access request together with issuing of the first memory access request when the first and second memory access requests include the same identification.

7. A method, comprising:
storing, in a queue element, a plurality of memory access requests to be issued to a memory device, the memory access requests including a store request and a load request;
deciding whether a first address of a first memory access request and a second address of a second memory access request relate with each other; and
issuing the second memory access request together with issuing of the first memory access request when it is decided that the first address and the second address relate with each other.

8. The method according to claim 7, further comprising:
deciding that the first address and the second address relate with each other when both of the first and second addresses correspond to a same unit of the memory device.

9. The method according to claim 7, further comprising:
deciding that the first and second addresses relate with each other when the first and second addresses belong to a same row address.

10. The method according to claim 7, further comprising:
deciding that the first and second addresses relate with each other when the first and second addresses belong to a same rank of the memory device.

11. The method according to claim 7, wherein both of the first and second requests comprise the store request, or comprise the load request.

12. The method according to claim 7, further comprising:
giving a same identification to the first and second memory access requests when the first and second memory access requests relate with each other; and
issuing the second memory access request together with issuing of the first memory access request when the first and second memory access requests include a same identification.
